(19) United States
(12) Patent Application Publication
(10) Pub. No.: US 2010/0322470 A1
(43) Pub. Date: Dec. 23, 2010

(54) WATERMARK COMMUNICATION AND CONTROL SYSTEMS

(76) Inventor: Tony F. Rodriguez, Portland, OR (US)

Correspondence Address: DIGIMARC CORPORATION, 9405 SW GEMINI DRIVE, BEAVERTON, OR, 97008, US

(21) Appl. No.: 12/855,374

(22) Filed: Aug. 12, 2010

Related U.S. Application Data
(63) Continuation of application No. 10/002,225, filed on Nov. 20, 2001, now abandoned.
(60) Provisional application No. 60/252,939, filed on Nov. 22, 2000.

(51) Int. Cl. G06K 9/00

(52) U.S. Cl. 382/100

(57) ABSTRACT

An enhanced television system (e.g., ATVEF-based) conveys enhancement data using an in-band, video watermark, channel. The system desirably is implemented using a layered architecture, so that the watermark nature of the communications channel is transparent to other layers that employ the enhancement data. Due to the in-picture nature of the communications channel, systems employing the detailed technology are not subject to some of the compatibility issues that are present with prior art techniques.

### RELATED APPLICATION DATA

This patent application is a continuation of U.S. patent application Ser. No. 10/002,225, filed Nov. 20, 2001 (published as US 2002-0066111 A1), which claims priority to U.S. Provisional Patent Application No. 60/252,939, filed Nov. 22, 2000. The above patent documents are hereby incorporated by reference in their entirety.

### FIELD OF THE INVENTION

The present invention relates to use of watermarks to convey data to electronic systems, and is particularly illustrated in the context of enhanced television systems.

### BACKGROUND AND SUMMARY OF THE INVENTION

Interactive television—a convergence between television and computers—has been heralded for a decade or more. To date, the technology has not found widespread acceptance. In part, this has been due to incompatibilities between television systems, such as NTSC and PAL.

One key component of interactive TV systems is a data channel to accompany the video. Numerous techniques have been proposed—the most common of which is to encode data in the vertical blanking interval (VBI) of traditional analog TV signals. Another is to modulate data onto scanline 21—a scanline that is usually positioned off-screen. Techniques that are commonly used with NTSC sometimes don't find favor with PAL, and vice versa.

Much work has been done in recent years in the field of video watermarking—the science of conveying data through slight changes to the video information presented to the viewer (“in-band”). The changes are so slight as to be imperceptible to the viewer, yet can be recovered by suitable signal processing. Illustrative techniques are shown in the assignee's U.S. Pat. No. 6,122,403 and application Ser. No. 09/138,061 (now U.S. Pat. No. 6,229,924) and Ser. No. 09/164,859 (now U.S. Pat. No. 6,374,036), and in patent documents WO99/45705 and WO 00/04722.

The focus of prior art video watermarking efforts has been to implement copy control functionality (e.g., to assure that copyrighted DVD video is not copied) and to provide some ownership marking of video content.

In accordance with a preferred embodiment of the present invention, watermark technology is employed as a data channel in an interactive television system. If the system relies on a consumer's set-top box (STB) to perform some of the system processing, the watermark processing operations can likewise be performed by the STB. Existing interactive TV systems can be modified to utilize a watermark communications channel by providing the requisite watermark processing function at a suitable layer in known interactive TV stack architectures.

A similar approach, of providing watermark functionality as an additional component of known layered architectures, can likewise permit watermark-based communication channels to be employed in existing Ethernet networks.

The foregoing and additional features and advantages of the present invention will be more readily apparent from the following detailed description.

### DETAILED DESCRIPTION

One emerging standard used in advanced television systems (and certain set top boxes) is known as ATVEF (Advanced Television Enhancement Forum—see the web site at the world wide web domain atvef.com; excerpts from this site were published in US 2002-0066111 A1). Through this standard, video content can produced once (using a variety of different tools), and can thereafter be distributed and displayed in a variety of environments (e.g., analog & digital, cable, satellite, distribution; display using STBs, digital TVs, analog TVs, PCs, PDAs, etc.). ATVEF is built on a number of other standards, including HTML 4.0, EcmaScript 1.1, and Multicast IP. In more technical jargon, ATVEF is a declarative content specification with scripting.

Several familiar broadcast programs already employ this technology, including Wheel of Fortune, and Jeopardy, to enhance the viewer experience. The recently-introduced AOL-TV is based on ATVEF-compliant technology.

At the consumer premises, a “presentation engine” is used to render the ATVEF content. One such presentation engine is known as ATSC's (Advanced Television Systems Committee) DASE, and sits on top of the application execution engine, with access provided via Java API calls.

Many implementations of the ATVEF system employ Multicast IP for data transmission. In Multicast IP, data is conveyed in a part of the video signal that is not presented for display to the viewer.

In order for video equipment to be compliant with the ATVEF standard, it must recognize the data conveyed with the content signal, and render it in accordance with the ATVEF specification. A layered architecture is generally employed.

Layered architectures are used in a variety of contexts. The lowest layer is commonly customized to the particular hardware being used. Higher layers are progressively more independent of the hardware—offering a hardware-independent interface for interacting with the system. By such approaches, software (and content) can more easily be used on a variety of different platforms, since the platform differences are masked by the layered architecture.

ATVEF-compliant set top box architectures include a cross-platform communication stack having a layer that provides detection of the Multicast IP data. This layer analyzes the video data for the Multicast information, and relays the decoded information to higher layers that make use of such information in augmenting the consumer's experience.

Likewise on the content origination side—a layered architecture is used. Such applications use stock IP protocols, such as Multicast or UDP. At (or near) the bottom of the stack different organizations have supplied a (Physical) layer to encode the signal into NTSC, PAL, DVB, etc. Traditionally, for each of these there is associated hardware (NABBTS encoder for NTSC, for example), that actually puts the data with the video.

In accordance with one embodiment of the invention, watermark encoder/decoder functionality is provided at a similar layer in compliant systems. On the content origination side, a physical layer is provided to watermark video in any desired video format (typically in the spatial domain, but alternatively watermarking in the compressed, e.g., DCT or MPEG, domains), hence reducing the amount of hardware and software needed to operate with different formats.

Likewise on the consumer side, a watermark detector is provided at a low level layer, serving to analyze the received video data for watermark information, and relay the decoded watermark information to higher layers that make use of such auxiliary information in augmenting the consumer's experience. (The video watermark decoder can be provided at the lowest—physical—layer, or at a higher level.)

By arrangements like that detailed above, interactive TV employs watermark data—conveyed “in-band” in image content, to augment the consumer's experience. Rather than implementing the technology differently for every origination system and set top box hardware (and associated STB operating system) on the market, the watermark functionality is desirably incorporated into a pre-existing layered communication architecture. By such approach, the installed based of content authoring tools, clients, and content is un-affected, and implementation is greatly simplified.

To provide a comprehensive disclosure without unduly lengthening this specification, the patents and applications cited above are incorporated herein by references, together with Ser. No. 09/571,422 (now U.S. Pat. No. 6,947,571).

Having described and illustrated the principles of the invention with reference to illustrative embodiments, it should be recognized that the invention is not so limited.

For example, while the specification referred to a few examples of watermarking technology, the field is broad and growing. Any watermarking technology can be employed.

The implementation of the functionality described above (including watermark decoding) is straightforward to artisans in the field, and thus not further belabored here. Conventionally, such technology is implemented by suitable software, stored in long term memory (e.g., disk, ROM, etc.), and transferred to temporary memory (e.g., RAM) for execution on an associated CPU. In other implementations, the functionality can be achieved by dedicated hardware, or by a combination of hardware and software. Reprogrammable logic, including FPGAs, can advantageously be employed in certain implementations. Set top boxes typically incorporate some or all of such elements.

It should be recognized that the particular combinations of elements and features in the above-detailed embodiments are exemplary only; the interchanging and substitution of these teachings with other teachings in this and the incorporated-by-reference patents/applications are also contemplated.

In view of the wide variety of embodiments to which the principles and features discussed above can be applied, it should be apparent that the detailed embodiments are illustrative only and should not be taken as limiting the scope of the invention. Rather, I claim as my invention all such modifications as may come within the scope and spirit of the following claims and equivalents thereof.

What is claimed is:

1. An interactive video consumer system employing a layered architecture comprising at least three layers, a lowest layer of the architecture being customized to particular hardware being used, and higher layers being progressively more independent of the hardware so as to offer hardware-independent interfaces for interacting with the system, the architecture including at least a physical layer and an application layer, such system providing enhanced consumer experience through computer data associated with video content, wherein a watermark decoder for decoding computer data from in-band video content is included in said physical layer, or in an intervening higher layer, but not so high as to be included in said application layer.

2. The system of claim 1 wherein said watermark decoder is provided in said physical layer.

3. The system of claim 1 wherein said watermark decoder is provided in a link layer.

4. The system of claim 1 in which the interactive video consumer system also includes a decoder for obtaining computer data transmitted with the video by multicast IP transmission.

5. A system comprising:
first and second consumer electronic apparatuses, each of said apparatuses including an input for receiving content information, each of said consumer electronic apparatuses implementing a layered architecture comprising at least four logical layers, the higher layers being progressively more independent of the hardware so as to offer hardware-independent interfaces for interacting with the apparatus, said first and second apparatuses comprising different hardware designs that are masked through use of said layered architectures;
the first apparatus including a first watermark decoder for decoding plural-bit watermark data steganographically embedded “in band” within content represented by the received content information, the first watermark decoder being located in a particular logical layer of the layered architecture of said first apparatus, and operative to relay decoded watermark data to a higher logical layer within said architecture to control an aspect of first apparatus operation;
the second apparatus including a second watermark decoder for decoding plural-bit watermark data steganographically embedded “in band” within content represented by the received content information, the second watermark decoder being located in a particular logical layer of a layered architecture of said second apparatus, and operative to relay decoded watermark data to a higher logical layer within said architecture to control an aspect of second apparatus operation;
wherein said first and second watermark decoders are of different design, yet said differences are masked by the layered architectures within said consumer electronic apparatuses, so that said higher logical layers are independent of the design of the watermark decoders.

6. The system of claim 5 in which the first watermark decoder is operative to decode plural-bit watermark data steganographically embedded within audio content.

7. The system of claim 5 in which the first watermark decoder is operative to decode plural-bit watermark data steganographically embedded within still image content.

8. The system of claim 5 in which the first watermark decoder is operative to decode plural-bit watermark data steganographically embedded within video content.

9. The method of claim 5 in which said higher logical layer in the first apparatus is responsive to said relayed watermark data to present additional content to a user of said first apparatus.
